(19) United States
(12) Patent Application Publication
(10) Pub. No.: US 2009/0293734 A1
(43) Pub. Date: Dec. 3, 2009

(54) BEVERAGE MAKER HAVING A THERMOSTAT FOR CONTROLLING THE OPERATION OF HEATING MEANS FOR HEATING WATER

(75) Inventor: Peng Chau Quah, Hoogeveen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/307,928

(22) PCT Filed: Jul. 3, 2007
(86) PCT No.: PCT/IB07/52576

§ 371 Date: Jan. 8, 2009

(30) Foreign Application Priority Data
Jul. 11, 2006 (EP) 06116942.1

(51) Int. Cl. A47J 31/047; B67D 5/63

(52) U.S. Cl. 99/281; 222/146.5

(57) ABSTRACT

A beverage maker comprises a boiler (10) having a container (20) for containing a quantity of water and a heating element (30) for heating the water During operation of the beverage maker, it is desirable to keep the temperature of the water within a predetermined range. Therefore, the operation of the heating element (30) is controlled by means of a thermostat (40) for either closing or interrupting an electronics circuit for energizing the heating element (30). In order to control the thermostat (40) in a sufficiently accurate manner, a temperature detecting member (41) of the thermostat (40) is adapted to detect a temperature of a portion (31) of a wall (26) of the container (20) that is connected to the heating element (30). As this location is capable of heating up at a relatively fast rate, delays in temperature detection are compensated for, and the hysteresis effect of the thermostat (40) is reduced.

### FIELD OF THE INVENTION

The present invention relates to a device for dispensing a hot liquid, comprising:

a boiler having an interior space for containing liquid, and heating means for supplying heat to the liquid;

an energizing circuit comprising a heating circuit for energizing the heating means of the boiler; and

a combination of a switching device which is arranged in the heating circuit, and which is capable of either interrupting or closing the heating circuit, and a temperature detecting member, which combination is adapted to interrupt the heating circuit in case a detected temperature is higher than a predetermined value, and to close the heating circuit in case a detected temperature is lower than a predetermined value.

The present invention is particularly applicable in a device for making a hot beverage.

### BACKGROUND OF THE INVENTION

In a process of preparing a hot beverage, a temperature of the water is an important factor. This is particularly true in the case of a process of preparing coffee on the basis of a quantity of ground coffee beans and hot water. In such a case, in order to have a good extraction of the ground coffee beans, it is preferred if the temperature of the water that is used in the coffee making process is between 90° C. and 96° C.

In many cases, a coffee maker comprises a boiler having an interior space for containing water, and heating means for supplying heat to the water. Such a boiler is capable of storing water at a suitable temperature, and dispensing the hot water for the purpose of performing a coffee brewing process by conducting the water through a quantity of ground coffee beans.

Normally, according to the state of the art, for the purpose of controlling the heating means of the boiler, a control circuit comprising a negative temperature coefficient sensor (NTC sensor) is applied. By means of such a control circuit, a temperature of water that is present inside the boiler is detected, and the heating means are switched on and off in a manner that is suitable for keeping the temperature of the water within the range of 90° C. to 96° C. Due to low mass, high sensitivity and low tolerance spread of NTC sensors, it is very well possible to control the temperature of the water inside the boiler with high accuracy. This is even true in case a coffee maker having a control circuit comprising a NTC sensor has been manufactured in mass production.

### SUMMARY OF THE INVENTION

Although the application of a control circuit comprising a NTC sensor for the purpose of controlling the temperature of water inside the boiler of the coffee maker yields very good results, it is desirable to replace this control circuit by a simple commercially available thermostat, in order to reduce the cost price of the coffee maker. In that case, the thermostat is arranged such as to switch the heating means of the boiler on and off on the basis of detected values of the temperature of the water that is present inside the boiler.

However, due to relatively large hysteresis and delays in temperature detection associated with a simple thermostat, it is not possible to replace the control circuit and the NTC sensor by a thermostat on the one hand and to maintain the required accuracy of controlling the temperature of the water that is present inside the boiler on the other hand. This is all the more true when the thermostat is used for directly detecting the temperature of the water, i.e. in a situation in which the parameter to be detected is the same as the parameter to be controlled.

It is an objective of the present invention to provide a solution according to which a simple thermostat may be applied for the purpose of controlling in a sufficiently accurate way the temperature of water that is present inside a boiler of a beverage maker for making a hot beverage. It is noted that this simple thermostat may be a thermostat having a cut off tolerance of ±5° C. and a hysteresis of 10° C. to 25° C., for example.

The objective is achieved by a device, comprising:

a boiler having an interior space for containing liquid, and heating means for supplying heat to the liquid;

an energizing circuit comprising a heating circuit for energizing the heating means of the boiler; and

a combination of a switching device which is arranged in the heating circuit, and which is capable of either interrupting or closing the heating circuit, and a temperature detecting member, which combination is adapted to interrupt the heating circuit in case a detected temperature is higher than a predetermined value, and to close the heating circuit in case a detected temperature is lower than a predetermined value;

wherein the temperature detecting member is adapted to detect a temperature at a location of the boiler that is capable of heating up at a rate which is higher than an average rate at which liquid that is present inside the boiler is capable of heating up.

According to the present invention, the temperature detecting member which is applied in combination with the switching device which is used for the purpose of either interrupting or closing the heating circuit for energizing the heating means of the boiler is arranged such as to be capable of detecting a temperature at a location of the boiler that heats up faster than the liquid inside the boiler when the heating means are in an operative state. In particular, a heating-up rate of this location is faster than an average heating-up rate of the liquid.

The concept of detecting a temperature at a location of the boiler that is capable of heating up at a rate which is higher than an average rate at which liquid that is present inside the boiler is capable of heating up, and operating the switching device on the basis of the temperature as detected, has many advantages. A number of these advantages will be mentioned in the following.

In the first place, it is possible to have a higher value of the set point for putting the switching device to an opened position, i.e. for switching off the switching device. Consequently, it is possible to have a higher value of the set point for putting the switching device to a closed position, i.e. for switching on the switching device, as the hysteresis is fixed.

In the second place, it is possible to apply a switching device having a relatively large mass and a relatively low heat transfer efficiency at its interface. Due to the fact that the location at which the temperature is detected heats up faster than the liquid inside the boiler, delay which is caused by the mass of the switching device and the heat transfer efficiency loss at the interface of the switching device are compensated for.

In the third place, the temperature detecting member may be used for the purpose of detecting a temperature of the heating means of the boiler. In such a case, the combination of the switching device and the temperature detecting member may additionally serve as a heater protection for switching off the heating means when there is no liquid in the boiler, so that there is no need for applying additional components for this purpose. The temperature detecting member may be directly in contact with the heating means of the boiler, but it is also possible that the temperature detecting member is in contact with a portion of a wall of the container of the boiler that is connected to the heating means.

All in all, by detecting a temperature at a location of the boiler that is capable of heating up at a rate which is higher than an average rate at which liquid that is present inside the boiler is capable of heating up, wherein the temperature of this location is directly depending on the operation of the heating means of the boiler, it is possible to control the switching device with higher accuracy than by directly detecting a more or less average temperature of the liquid that is present inside the boiler. Therefore, when the present invention is put to practice, it is possible to use a relatively simple thermostat, wherein there is no need for using a control circuit having a NTC sensor or the like.

According to a practical possibility, in case the heating means of the boiler are connected to a portion of a wall of the container of the boiler, at an inside of the boiler, for example through welding or brazing, the temperature detecting member may be arranged such as to be in contact with this portion of the wall of the container of the boiler, at an outside of the boiler. The connection between the heating means and the portion of the wall of the container of the boiler may be established by means of a thermal bridge, for example. However, it is also possible that the heating means are directly connected to the wall of the container of the boiler.

Within the scope of the present invention, it is also possible that the temperature detecting member is in contact with the heating means, through an opening in a portion of the container of the boiler. In this situation, the combination of the switching device and the temperature detecting member is also applicable as a heater protection for switching off the heating means when there is no liquid in the boiler and the temperature of the heating means quickly rises to a dangerously high level as soon as the heating means are switched on.

According to another possibility, the temperature detecting member is arranged in a wall of the container of the boiler, at a position close to the heating means of the boiler, and flow diverting means are arranged in the container of the boiler for the purpose of directing liquid to the temperature detecting member. In this embodiment of the device according to the present invention, the temperature detecting member is used for detecting a temperature of liquid that is surrounding the heating means, and that heats up faster than the rest of the liquid that is present inside the boiler.

Advantageously, the location of the boiler that is associated with the temperature detecting member is not only capable of heating up at a rate which is higher than an average rate at which liquid that is present inside the boiler is capable of heating up, but is also capable of cooling down at a rate which is higher than an average rate at which liquid that is present inside the boiler is capable of cooling down.

By detecting a temperature at a location of the boiler that cools down faster than the liquid inside the boiler when the heating means are in an inoperative state, it is possible to apply a switching device involving a relatively large hysteresis effect. As the location at which the temperature is detected cools down faster than the liquid inside the boiler, the switching device will be switched on and the heating means of the boiler will be energized before the temperature of the liquid reaches the set point for switching on the switching device. In this way, the hysteresis effect of the switching device is reduced.

When the temperature detecting member is in contact with a portion of the wall of the container of the boiler, an adjacent portion of the wall of the container may be provided with cooling fins. In this way, it is ensured that a cooling-down rate of the portion of the wall of the container of the boiler where the temperature is measured is higher than an average cooling-down rate of the liquid that is present inside the boiler.

It is noted that in practice, a lower portion of the boiler cools down faster than an upper portion of the boiler, due to the fact that cold liquid is heavier than hot liquid. The liquid that is cooled down under the influence of contact to an inner surface of the container of the boiler will move down to the lower portion of the boiler. Consequently, a thin layer of liquid at a lower temperature is formed at a bottom of the boiler. For example, when water is heated to above 90° C. and is allowed to cool down naturally, a temperature difference between top and bottom of a boiler containing the water can be around 7-12° C. In view of this, it is advantageous to position the temperature detecting member at a location close to the heating means, in a lower portion of the boiler, as a heating-up rate and a cooling-down rate of such a location are higher than an average heating-up rate and an average cooling-down rate of the liquid that is present inside the boiler.

Measuring a temperature at a location of the boiler that is capable of cooling down at a rate which is higher than an average rate at which liquid that is present inside the boiler is capable of cooling down is beneficial to the accuracy of controlling the switching device which is arranged in the heating circuit. It is preferred if the temperature detecting member is adapted to detect a temperature at a location of the boiler that is capable of both heating up and cooling down at rates which are higher than average rates at which liquid that is present inside the boiler is capable of heating up and cooling down. However, beneficial effects are already obtained in case one of the heating-up rate and the cooling-down rate of the location where the temperature measurements are performed is relatively high. In view of this, the present invention also relates to a device for dispensing a hot liquid, comprising:

a boiler having an interior space for containing liquid, and heating means for supplying heat to the liquid;

an energizing circuit comprising a heating circuit for energizing the heating means of the boiler; and

a combination of a switching device which is arranged in the heating circuit, and which is capable of either interrupting or closing the heating circuit, and a temperature detecting member, which combination is adapted to interrupt the heating circuit in case a detected temperature is higher than a predetermined value, and to close the heating circuit in case a detected temperature is lower than a predetermined value;

wherein the temperature detecting member is adapted to detect a temperature at a location of the boiler that is capable of cooling down at a rate which is higher than an average rate at which liquid that is present inside the boiler is capable of cooling down.

In order to realize a relatively low cost price of the device according to the present invention, it is preferred if the combination of the switching device and the temperature detecting member is part of a commercially available mechanical thermostat. In such a case, when the present invention is applied, it is still possible to control the operation of the switching device with sufficient accuracy for keeping a temperature of the liquid that is present inside the boiler within a predetermined range.

The above-described and other aspects of the present invention will be apparent from and elucidated with reference to a number of combinations of a boiler and a thermostat as described hereinafter.

### BRIEF DESCRIPTION OF THE DRAWINGS

The present invention will now be explained in greater detail with reference to the figures, in which equal or similar parts are indicated by the same reference signs, and in which:

FIG. 1 is a graph illustrating a relation of a temperature that is detected by a thermostat of a beverage maker according to the present invention to a temperature of water that is present inside a boiler of the beverage maker;

FIG. 2 diagrammatically shows a sectional view of a boiler and a thermostat of a beverage maker according to a first preferred embodiment of the present invention;

FIG. 3 diagrammatically shows a sectional view of a boiler and a thermostat of a beverage maker according to a second preferred embodiment of the present invention; and

FIG. 4 diagrammatically shows a sectional view of a boiler and a thermostat of a beverage maker according to a third preferred embodiment of the present invention; and

FIG. 5 diagrammatically shows a sectional view of a boiler and a thermostat of a beverage maker according to a fourth preferred embodiment of the present invention.

### DETAILED DESCRIPTION OF EMBODIMENTS

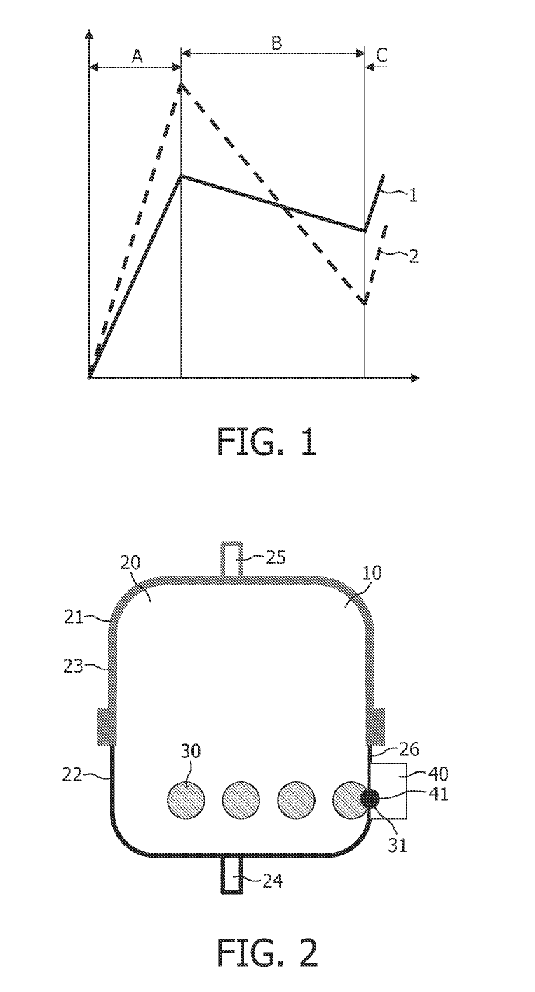

The effects which are obtained when the present invention is put to practice are elucidated on the basis of FIG. 1, which is a graph illustrating a relation of a temperature of water that is present inside a boiler of a beverage maker according to the present invention to a temperature that is detected by a thermostat of the beverage maker, at a location of the boiler. In the figure, a continuous line representing the temperature of the water over time is indicated by the reference numeral 1, and a dashed line representing the detected temperature over time is indicated by the reference numeral 2. It is noted the graph is associated with a situation in which a temperature detecting member of the thermostat is adapted to detect a temperature at a location of the boiler that is capable of heating up and cooling down at rates which are higher than average rates at which water that is present inside the boiler is capable of heating up and cooling down.

When a heating process inside the boiler is started, and the heating means of the boiler are put to an operative state, both the water inside the boiler and the location at which the temperature is detected are heated up, starting from a common initial temperature, wherein a heating-up rate of the location at which the temperature is detected is higher than an average heating-up rate of the water. From a left-hand portion A of FIG. 1, which is associated with the operative state of the heating means of the boiler, it is clear that in the same period of time, the detected temperature gets higher than the temperature of the water.

When the detected temperature has reached an upper set point of the thermostat, the heating means of the boiler are switched off. As a result, both the water inside the boiler and the location at which the temperature is detected cool down, wherein a cooling-down rate of the location at which the temperature is detected is higher than an average cooling-down rate of the water. From an intermediate portion B of FIG. 1, which is associated with the inoperative state of the heating means of the boiler, it is clear that in the same period of time, the detected temperature starts at a higher level and ends at a lower level than the temperature of the water.

When the detected temperature has reached a lower set point of the thermostat, the heating means of the boiler are switched on again, and both the water inside the boiler and the location at which the temperature is detected are heated up again. A right-hand portion C of FIG. 1 corresponds to an initial period of the new heating process. During operation of the beverage maker, processes of heating up the water inside the boiler and cooling down the water inside the boiler are alternated for the purpose of keeping the temperature of the water within a predetermined range. For example, this range may be 90° C. to 96° C.

As the location at which the temperature which is used for controlling the thermostat is detected is a location having higher heating-up and cooling-down rates than the water that is present inside the boiler, an enlarged version of the temperature of the water is taken into account, as it were. FIG. 1 clearly shows that a temperature rise of the detected temperature is larger than a temperature rise of the temperature of the water in a period A, C during which the heating means of the boiler are operated, and that a temperature drop of the detected temperature is larger than a temperature drop of the temperature of the water in a period B during which the heating means of the boiler are in an inoperative state. As a result of detecting the temperature at a location which is more sensitive to the state of the heating means, the thermostat may be accurately controlled for keeping the temperature of the water that is present inside the boiler within the predetermined range. In particular, as the location where the temperature is detected heats up faster than the water, both a delay in temperature detection due to the mass of the thermostat and a loss of heat transfer efficiency at the thermostat interface are compensated for. Furthermore, as the location where the temperature is detected cools down faster than the water, the heating means of the boiler are switched on again to resume a heating process before the temperature of the water reaches the lower set point of the thermostat, so that the hysteresis effect of the thermostat is reduced.

Each of FIGS. 2-5 shows a boiler 10 and a thermostat 40 of a beverage maker according to a preferred embodiment of the present invention, thereby illustrating practical ways of applying measures of the present invention.

The boiler 10 and the thermostat 40 as shown in each of FIGS. 2-5 are part of a beverage maker for making hot beverages. Such a beverage maker may be a coffee maker which is capable of making coffee on the basis of a quantity of hot water and a quantity of ground coffee beans, for example. Besides the boiler 10 for containing and heating water, a known type of coffee maker comprises a water tank for containing water, a brewing chamber for containing the ground coffee beans, and a pump for pumping water from the water tank to the boiler 10, and from the boiler 10 to the brewing chamber. During operation of the coffee maker, the water inside the boiler 10 is heated, and is kept at a temperature which is right in view of a coffee brewing process. When the pump is operated, hot water is displaced from the boiler 10 to the brewing chamber, while at the same time, cold water is displaced from the water tank to the boiler 10. In the brewing chamber, the hot water flows through the ground coffee beans, and the coffee is obtained.

The functioning of a beverage maker according to the present invention will not be further explained, as the invention only pertains to the boiler 10 of the beverage maker and the way in which heating means 30 of the boiler 10 are controlled for the purpose of keeping a temperature of water that is present inside the boiler 10 within a predetermined range.

FIG. 2 shows a boiler 10 of a beverage maker according to a first preferred embodiment of the present invention. The boiler 10 has a container 20 for containing water and an electric heating element 30 for heating water. A housing 21 of the container 20 comprises a metal lower shell 22 and a plastic upper shell 23, which are connected to each other. In the lower shell 22 of the housing 21, a water inlet 24 is arranged, whereas in the upper shell 23 of the housing 21, a water outlet 25 is arranged.

At a connection point 31, the heating element 30 is welded to the inside of an upright wall 26 of the metal lower shell 22 of the housing 21 of the container 20. At the outside of the upright wall 26, a thermostat 40 is arranged, wherein a temperature detecting member 41 of the thermostat 40 is in contact with the upright wall 26, at a position corresponding to the connection point 31. Hence, the temperature detecting member 41 of the thermostat 40 is adapted to detect a temperature of the metal lower shell 22 of the housing 21 of the container 20, at the position of the point 31 where the heating element 30 is connected to the lower shell 22.

The thermostat 40 is arranged in an electronics circuit for energizing the heating element 30, and is capable of switching from a closed position to an opened position, and vice versa. As long as the thermostat 40 is in a closed position, the electronics circuit for energizing the heating element 30 is closed, and the heating element 30 is operated such as to generate heat. When the thermostat 40 is in an opened position, the electronics circuit for energizing the heating element 30 is interrupted, and the heating element 30 is put to an inoperative state.

When the thermostat 40 is in the closed position, and the temperature that is detected by the temperature detecting member 41 reaches an upper set point of the thermostat 40, the thermostat 40 switches to the opened position. From that moment on, the heating element 30 does not generate any heat, and the temperature that is detected by the temperature detecting member 41 decreases. When this temperature reaches a lower set point of the thermostat 40, the thermostat 40 switches back to the closed position again. At that point, the heating element 30 is energized, so that the detected temperature increases again. The process of switching the thermostat 40 on and off, i.e. putting the thermostat to the closed position and the opened position is continued until there is no longer a need for keeping the temperature of the water inside the boiler 10 at a certain level. On the basis of the fact that the detected temperature is the temperature of the metal lower shell 22 of the housing 21 of the container 20 at the position of the point 31 where the heating element 30 is connected to the lower shell 22, and not the average temperature of the water, the operation of the heating element 30 is accurately controlled, as has already been explained in the foregoing. In this respect, for sake of completeness, it is noted that the heating-up rate and the cooling-down rate of the metal lower shell 22 are higher than the average heating-up rate and the average cooling-down rate of the water inside the boiler 10.

On the basis of the fact that the detected temperature is directly related to the temperature of the heating element 30 instead of the temperature of the water inside the boiler 10, the thermostat 40 is also suitable to be used as a heater protection for interrupting the electronics circuit for energizing the heating element 30 when the temperature of the heating element 30 gets too high as a result of a lack of water in the boiler 10.

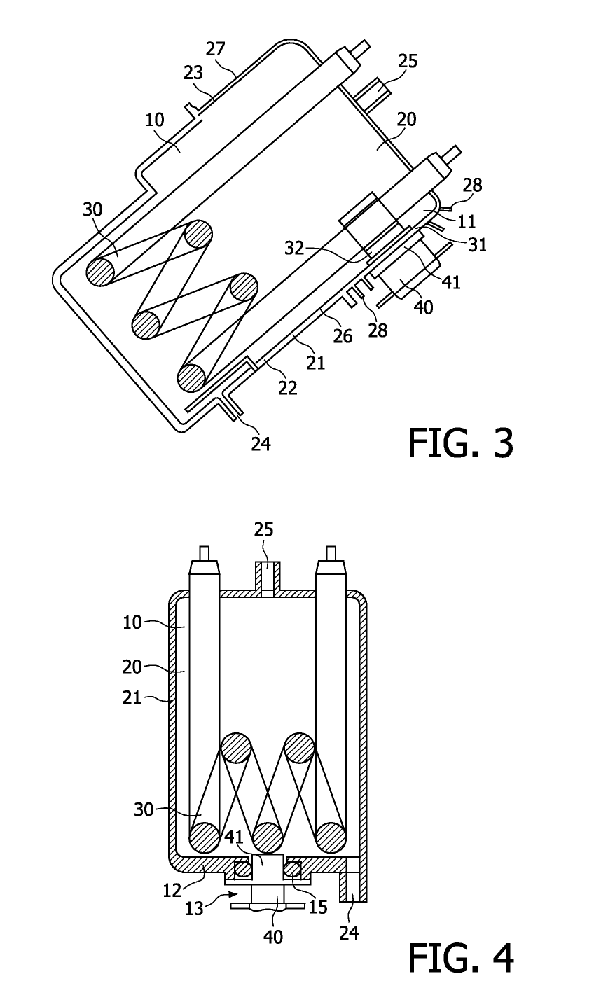

FIG. 3 shows a boiler 10 of a beverage maker according to a second preferred embodiment of the present invention, wherein the boiler 10 is shown in an orientation that is associated with an operative state and orientation of the beverage maker.

Like the boiler 10 as shown in FIG. 2, the boiler 10 of the beverage maker according to the second preferred embodiment of the present invention comprises a container 20 and an electric heating element 30, wherein a housing 21 of the container 20 comprises a lower shell 22 and an upper shell 23, wherein a water inlet 24 is arranged in the lower shell 22 of the housing 21, and wherein a water outlet 25 is arranged in the upper shell 23 of the housing 21. The boiler 10 has an inclined orientation, wherein upright walls 26, 27 of the shells 22, 23 of the housing 21 of the container 20 are extending at an angle with respect to the vertical.

A thermostat 40 is attached to the outside of the upper shell 23 of the housing 21 of the container 20, at an upper-lower corner 11 of the boiler 10. A temperature detecting member 41 of the thermostat 40 is adapted to detect a temperature of a portion 31 of the upright wall 27 of the upper shell 23 that is connected to the heating element 30, through a thermal bridge 32. In this way, it is ensured that the location at which the temperature is detected by the temperature detecting member 41 of the thermostat 40 heats up at a faster rate than the water that is inside boiler 10. For the purpose of ensuring that the location at which the temperature is detected by the temperature detecting member 41 of the thermostat 40 cools down at a faster rate than the water that is inside boiler 10, cooling fins 28 are arranged at the outside of the upper shell 23 of the housing 21 of the container 20.

For sake of completeness, it is noted that the thermal bridge 32 may have any suitable shape and size, and may comprise any suitable material.

FIG. 4 shows a boiler 10 of a beverage maker according to a third embodiment of the present invention. Like the boilers 10 shown in FIGS. 2 and 3, this boiler 10 comprises a container 20 and an electric heating element 30.

In a bottom portion 12 of a housing 21 of the container 20, an opening 13 is arranged, wherein a thermostat 40 is accommodated in this opening 13, and wherein a temperature detecting member 41 of the thermostat 40 is in direct contact with the heating element 30. In the shown example, an O-ring 15 is arranged around the thermostat 40 extending through the opening 13, in order to prevent water from leaking from the boiler 10.

During operation of the beverage maker, the heating-up and the cooling-down of the heating element 30 are directly detected by the temperature detecting member 41 of the thermostat 40, as a result of which the operation of the thermostat 40 may be controlled in a way which is far more accurate than controlling the thermostat 40 on the basis of a detection of the temperature of the water that is present inside the boiler 10, as has already been explained in the foregoing.

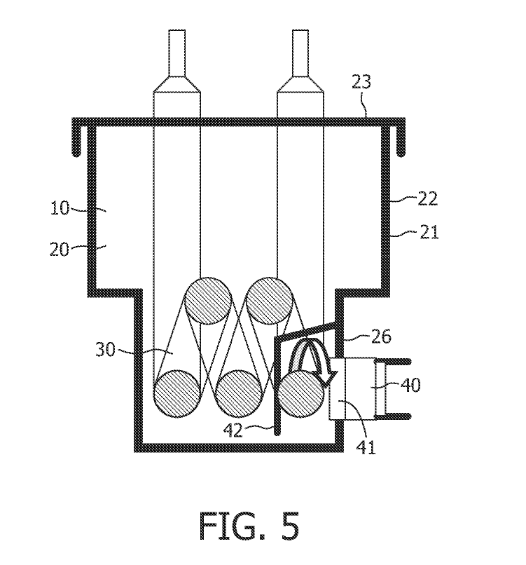

FIG. 5 shows a boiler 10 of a beverage maker according to a fourth embodiment of the present invention. Like the boilers 10 as described in the foregoing, this boiler 10 comprises a container 20 and an electric heating element 30. A housing 21 of the container 20 comprises a plastic lower portion 22 and a metal upper cover 23, which are connected to each other.

In this example, a temperature detecting member 41 of a thermostat 40 is not connected to the heating element 30, neither directly nor indirectly. Instead, the temperature detecting member 41 is arranged in an upright wall 26 of the plastic lower portion 22 of the housing 21 of the container 20. Furthermore, the boiler 10 comprises a flow diverter 42 which is capable of directing water that has just been heated by the heating element 30 to the temperature detecting member 41 of the thermostat 40. In FIG. 5, a circulation of heated water is diagrammatically depicted by means of a bent arrow. As the water that has just been heated by the heating element 30 and that is directed to the temperature detecting member 41 heats up at a rate that is higher than an average heating-up rate of water inside the boiler 10, the operation of the thermostat 40 is controlled in a most advantageous and accurate way, as has already been described in the foregoing.

For sake of completeness, it is noted that within the scope of the present invention, the flow diverter 42 may have any suitable shape, wherein it is important that the flow diverter 42 is capable of directing heated water away from the heating element 30, along the temperature detecting member 41 of the thermostat 40.

It will be clear to a person skilled in the art that the scope of the present invention is not limited to the examples discussed in the foregoing, but that several amendments and modifications thereof are possible without deviating from the scope of the present invention as defined in the attached claims. While the present invention has been illustrated and described in detail in the figures and the description, such illustration and description are to be considered illustrative or exemplary only, and not restrictive. The present invention is not limited to the disclosed embodiments.

Among other things, the shape of the heating element 30 and the shape of the housing 21 of the container 20 of the boiler 10 are not essential, and may therefore be chosen freely within the scope of the present invention, provided that the application of the measures of the present invention in the boiler 10 is not rendered impossible. For example, the housing 21 of the container 20 may comprise two shells 22, 23, but may also be manufactured as a single piece. Like many known heating elements, the heating element 30 may comprise a coil-shaped portion for realizing sufficient heating surface over a predetermined length.

It should be understood that although the boiler 10 and the thermostat 40 are described as being part of a beverage maker, in particular a beverage maker which is suitable for making coffee, the present invention is applicable in any device which is adapted to dispense a hot liquid.

Other variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the present invention.

In the foregoing, a beverage maker for making and supplying quantities of hot beverages has been described, which comprises a boiler 10 having a container 20 for containing a quantity of water and a heating element 30 for heating the water. During operation of the beverage maker, it is desirable to keep the temperature of the water within a predetermined range. Therefore, the operation of the heating element 30 is controlled by means of a thermostat 40 for either closing or interrupting an electronics circuit for energizing the heating element 30.

In order to control the thermostat 40 in a sufficiently accurate manner, a temperature detecting member 41 of the thermostat 40 is adapted to detect a temperature at a location of the boiler 10 that is capable of heating up and cooling down at rates which are higher than average rates at which water that is present inside the boiler 10 is capable of heating up and cooling down. An example of such a location is a portion 31 of a wall 26, 27 of the container 20 of the boiler 10 that is connected to the heating element 30. As a result of performing temperature measurements at a location which is capable of heating up at a relatively fast rate, delays in temperature detection are compensated for, and the hysteresis effect of the thermostat 40 is reduced.

1. Device for dispensing a hot liquid, comprising:
a boiler (10) having an interior space (20) for containing liquid, and heating means (30) for supplying heat to the liquid;
an energizing circuit comprising a heating circuit for energizing the heating means (30) of the boiler (10); and
a combination of a switching device (40) which is arranged in the heating circuit, and which is capable of either interrupting or closing the heating circuit, and a temperature detecting member (41), which combination is adapted to interrupt the heating circuit in case a detected temperature is higher than a predetermined value, and to close the heating circuit in case a detected temperature is lower than a predetermined value;
wherein the temperature detecting member (41) is adapted to detect a temperature at a location of the boiler (10) that is capable of heating up at a rate which is higher than an average rate at which liquid that is present inside the boiler (10) is capable of heating up.

2. Device according to claim 1, wherein the heating means (30) of the boiler (10) are connected to a portion (31) of a wall (26, 27) of the container (20) of the boiler (10), at an inside of the boiler (10), and wherein the temperature detecting member (41) is in contact with this portion (31) of the wall (26, 27) of the container (20) of the boiler (10), at an outside of the boiler (10).

3. Device according to claim 2, wherein the connection between the heating means (30) of the boiler (10) and the portion (31) of the wall (26, 27) of the container (20) of the boiler (10) is established by means of a thermal bridge (32).

4. Device according to claim 1, wherein the temperature detecting member (41) is in contact with the heating means (30), through an opening (13) in a portion (12) of the container (20) of the boiler (10).

5. Device according to claim 1, wherein the temperature detecting member (41) is arranged in a wall (26) of the container (20) of the boiler (10), at a position close to the heating means (30) of the boiler (10), and wherein flow diverting means (42) are arranged in the container (20) of the boiler (10) for the purpose of directing liquid to the temperature detecting member (41).

6. Device according to claim 1, wherein the location of the boiler (10) that is associated with the temperature detecting member (41) is also capable of cooling down at a rate which is higher than an average rate at which liquid that is present inside the boiler (10) is capable of cooling down.

7. Device according to claim 6, wherein the temperature detecting member (41) is in contact with a portion (31) of a wall (27) of the container (20) of the boiler (10), and wherein an adjacent portion of the wall (27) of the container (20) is provided with cooling fins (28).

8. Device according to claim 1, wherein the combination of the switching device (40) and the temperature detecting member (41) is part of a mechanical thermostat.

9. Device for dispensing a hot liquid, comprising:
a boiler (10) having an interior space (20) for containing liquid, and heating means (30) for supplying heat to the liquid;
an energizing circuit comprising a heating circuit for energizing the heating means (30) of the boiler (10); and
a combination of a switching device (40) which is arranged in the heating circuit, and which is capable of either interrupting or closing the heating circuit, and a temperature detecting member (41), which combination is adapted to interrupt the heating circuit in case a detected temperature is higher than a predetermined value, and to close the heating circuit in case a detected temperature is lower than a predetermined value;
wherein the temperature detecting member (41) is adapted to detect a temperature at a location of the boiler (10) that is capable of cooling down at a rate which is higher than an average rate at which liquid that is present inside the boiler (10) is capable of cooling down.

10. Device according to claim 9, wherein the temperature detecting member (41) is in contact with a portion (31) of a wall (27) of the container (20) of the boiler (10), and wherein an adjacent portion of the wall (27) of the container (20) is provided with cooling fins (28).

11. Device according to claim 9, wherein the temperature detecting member (41) is in contact with a lower portion (22) of a housing (21) of the container (20) of the boiler (10).
